(19) United States
(12) Patent Application Publication
(10) Pub. No.: US 2007/0047918 A1
(43) Pub. Date: Mar. 1, 2007

(54) Apparatus and method for recording moving picture

(75) Inventor: Hong-joon Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/504,663

(22) Filed: Aug. 16, 2006

(30) Foreign Application Priority Data
Aug. 25, 2005 (KR) 10-2005-0078319

(51) Int. Cl. H04N 5/91

(52) U.S. Cl. 386/107

(57) ABSTRACT

An apparatus and method for recording a moving picture is disclosed, whereby the moving picture captured by the apparatus is converted into a file and stored in a memory. The method for recording a moving picture includes capturing moving pictures to generate at least one moving-picture file, selecting the moving-picture files included in a interval among the generated moving-picture files, combining the selected moving-picture files, and storing the combined moving-picture files.

### CROSS-REFERENCE TO RELATED APPLICATION

This application is based on and claims priority from Korean Patent Application No. 10-2005-0078319 filed on Aug. 25, 2005, the disclosure of which is incorporated herein in its entirety by reference.

### BACKGROUND OF THE INVENTION

1. Field of the Invention

Aspects of the present invention relate to an apparatus and method for recording a moving picture, and more particularly to an apparatus and method for recording a moving picture, whereby the moving picture recorded by the apparatus is converted into a file and stored in a memory.

2. Description of the Related Art

A digital camera is an apparatus for capturing and storing an image. Specifically, an image entering through a lens is converted into an electrical signal using a photoelectric conversion device such as a charge coupled device (CCD), and the electrical signal is then stored in a memory device such as a semiconductor memory device or a magnetic tape.

Examples of the digital camera include a digital still camera (DSC) and a digital video camera (DVC). The digital still camera intermittently captures images and stores them in a semiconductor memory device, while the digital video camera successively captures images and stores them in a storage medium such as a magnetic tape.

With the rapid development of digital memory technology, mass-storage digital memory devices of the digital camera are replacing analog memory devices such as the related art magnetic tape. In other words, processes of the digital memory device capture, compress, and store moving pictures in a digital format. The digital memory device may be included in an external computer that can communicate with the digital camera via universal serial bus (USB), a parallel port, or others. Alternatively, the digital memory may reside in the digital camera due to improved integration and miniaturization of memory devices.

In addition to the development of memory technology, according to moving-picture compression technology such as MPEG-4 and H.264, a user of the digital camera can produce and store moving pictures at any time and place.

Such related art memory technology has reached a storage capacity and speed that satisfies user demands. However, unlike a computer, the digital camera is limited in the input and output devices it can support. Therefore, the digital camera mainly captures and stores moving pictures, while a separate external apparatus such as a computer edits the moving pictures.

A related art method for capturing/storing moving pictures in a related art digital camera will now be described. First, once a “record” button is pressed to capture moving pictures, image capturing starts. Then, when a “stop” button is pressed, the image capturing is ended and, thus, one moving-picture file is generated. A single “record/stop” button may be provided. In this case, recording starts if the “record/stop” button is pressed, and the recording ends if the “record/stop” button is pressed once more.

An example of a related art file system is shown in FIG. 1. If the digital camera captures/records a still picture, moving picture, or sound, the file system stores a still picture file 11, a moving-picture file 12, or sound files 13 and 14 in a predetermined folder.

The moving-picture file 12 compresses moving pictures using a predetermined codec, and stores the compressed moving picture in a main memory. The moving-picture file 12 includes sound compressed in a manner different from that of the moving pictures.

Generally, when a moving picture is recorded using the record/stop button, a predetermined serial number is given to the moving-picture file, and the moving picture is stored. For example, a moving-picture file “MOV0001.AV1” is generated by a first combination of the record/stop button, and a moving-picture file “MOV0002.AV1” is generated by a second combination of the record/stop button. In this way, moving-picture files can be stored in the main memory by increasing the index number until the main memory is filled.

However, in the case where the user films one event using the digital camera, the whole event is rarely captured in one successive filming, but the event is captured in several moving pictures by pressing the record/stop button several times.

If the moving pictures are captured by a tape camcorder and stored in a serial, physical medium such as a magnetic tape, a plurality of pictures are recorded in the physical medium. In this case, the problem of separate files for one event does not occur.

However, if the moving pictures are taken by the digital camera, the moving pictures are respectively stored in separate moving-picture files. In this case, several moving-picture files or several tens of moving-picture files may be generated when filming one event. As such, the user must edit the moving-picture files using a separate moving-picture editing tool to arrange the moving-picture files into one file. Moreover, users unaccustomed to computers or software may have difficulty performing such editing work.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an improved method and apparatus for recording moving-picture files by a digital camera.

According to an aspect of the present invention, there is provided a method for recording a moving picture in accordance with a user's recording command, which includes taking moving pictures to generate at least one moving-picture file, selecting the moving-picture files included in a interval among the generated moving-picture files, combining the selected moving-picture files, and d) storing the combined moving-picture files.

According to another aspect of the present invention, there is provided an apparatus for recording a moving picture in accordance with a user's recording command, which includes a means for taking moving pictures to generate at least one moving-picture file, a means for selecting the moving-picture files included in a interval among the generated moving-picture files, a means for combining the selected moving-picture files, and a main memory for storing the combined moving-picture files.

### BRIEF DESCRIPTION OF THE DRAWINGS

The above and other aspects of the present invention will be more apparent from the following detailed description of exemplary embodiments taken in conjunction with the accompanying drawings, in which:

FIG. 1 illustrates an example of a file system of a related art digital camera;

FIG. 2 illustrates a method for recording a moving-picture file in a related art digital camera;

FIG. 3 illustrates a method for recording a moving picture in accordance with the exemplary embodiment of the present invention;

FIG. 4 illustrates an example of a display window that asks a user whether to release the chapter-on state;

FIG. 5 illustrates an example of a display window for selecting a chaptering manner;

FIG. 6 is a block diagram illustrating the construction of an apparatus for recording a moving picture in accordance with the first exemplary embodiment of the present invention;

FIG. 7 illustrates an example of a structure of a moving-picture file;

FIG. 8 is a block diagram illustrating the construction of an apparatus for recording a moving picture in accordance with the second exemplary embodiment of the present invention;

FIG. 9 illustrates an example where a chapter button is pressed during recording of a moving picture;

FIG. 10 illustrates an example where a chapter button is pressed; and

FIG. 11 is a flowchart illustrating a method for recording a moving picture in accordance with the exemplary embodiment of the present invention.

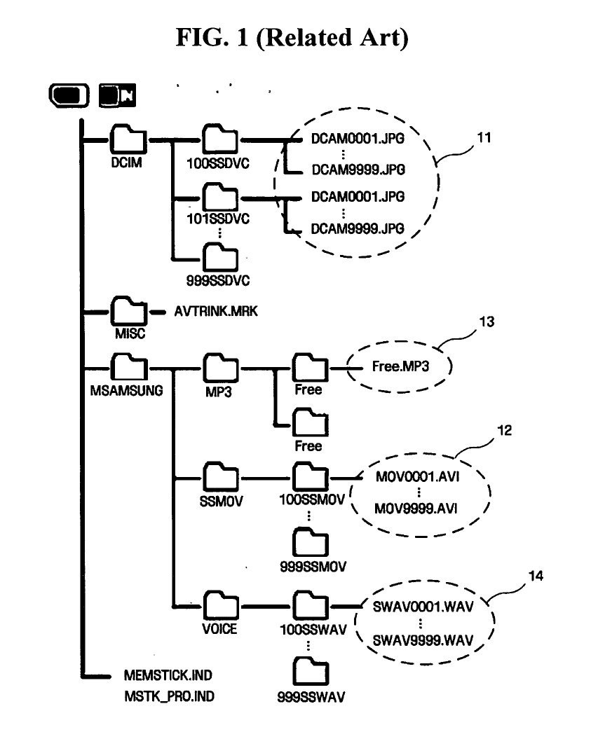

### DETAILED DESCRIPTION OF THE EXEMPLARY EMBODIMENTS

Hereinafter, exemplary embodiments will be described in detail with reference to the accompanying drawings. The aspects and features of the present invention and methods for achieving the aspects and features will be apparent by referring to the embodiments to be described in detail with reference to the accompanying drawings. However, the present invention is not limited to the exemplary embodiments disclosed hereinafter, but will be implemented in diverse forms. The matters defined in the description, such as the detailed construction and elements, are nothing but specific details provided to assist those of ordinary skill in the art in a comprehensive understanding of the exemplary embodiments, as defined within the scope of appended claims. In the detailed description, the same drawing reference numerals are used for the same elements across various figures.

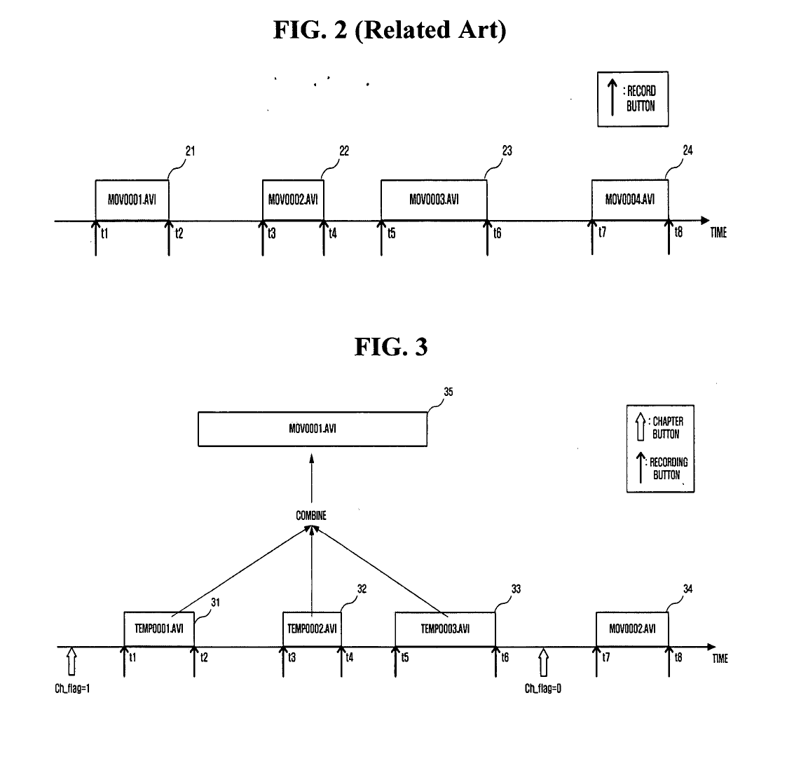

The basic concept of the exemplary embodiments will be described with reference to FIG. 2 and FIG. 3. FIG. 2 illustrates a method for recording a moving-picture file in a related art digital camera, and FIG. 3 illustrates a method for recording a moving picture in accordance with an exemplary embodiment of the present invention. Since a single record/stop button is provided, recording starts if the record/stop button is activated, and recording ends if the record/stop button is activated once more. Therefore, a single record/stop button will be described. Of course, separate record and stop buttons may be provided, or equivalent structures to buttons as would be known by those skilled in the art may be provided.

Referring to FIG. 2, to generate moving-picture files, a user presses the record button once more after it has been pressed twice. If the user presses the record button eight times, four moving-picture files 21, 22, 23 and 24 are generated as shown in FIG. 2.

On the other hand, in the exemplary embodiment, a plurality of moving-picture files corresponding to a interval having a chapter flag Ch_flag of “1” are combined as shown in FIG. 3. However, the moving-picture files are stored in a interval having a chapter flag of “0” in the substantially same manner as the related art mode (i.e., one moving-picture file is generated by two activations of the record button).

The chapter flag is originally set to “0.” Then, the chapter flag is set to “1” (ON) if a button (hereinafter, referred to as a “chapter button”) is pressed, and the chapter flag is set to “0” (OFF) if the chapter button is pressed once more. As used throughout this application, the term “pressed” refers to any manner of transiting the recording between its start and stop states, as would be understood by those skilled in the art.

In a first exemplary embodiment of the present invention, temporary moving-picture files 31, 32 and 33 corresponding to a interval having a chapter flag of “1” may be temporarily stored in a buffer. When the chapter flag is set to “0”, the temporary moving-picture files 31, 32 and 33 are combined into one moving-picture file 35, and then stored in a main memory. Since the moving-picture files 31, 32 and 33 are not combined into one moving-picture file 35 after the chapter flag is set to “0”, a moving-picture file 34 stored by the record button is directly stored in the main memory, not the buffer.

In a second exemplary embodiment of the present invention, all the moving-picture files 31, 32, 33 and 34 are stored in the main memory without using the buffer, and moving-picture files are only combined using temporal information. In other words, after the chapter flag is set to “1”, if the chapter flag is set to “0”, the moving-picture files 31, 32 and 33 stored in the main memory are combined. At this time, after the moving-picture files 31, 32 and 33 are shifted from the main memory to the buffer, they may be combined into one moving-picture file 35.

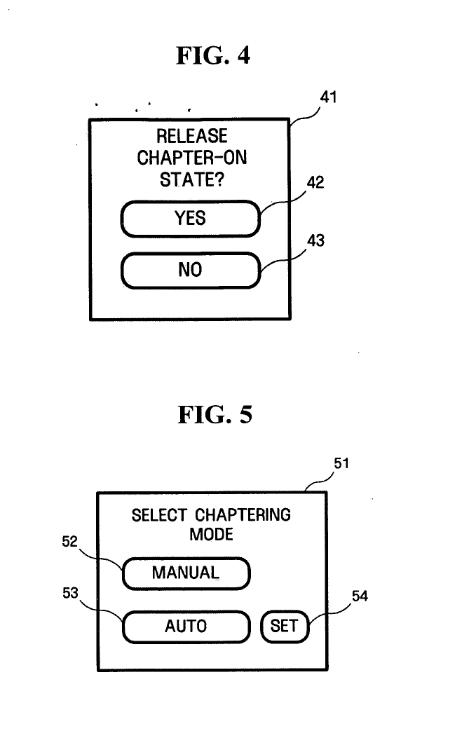

Meanwhile, in the case of the chapter flag having been set to “1,” if a power-off button is pressed in a state where the chapter button has not been pressed, the moving pictures are not combined. In this case, a problem may occur. Therefore, if the power-off button is pressed in a state where the chapter flag has been set to “1,” the display window 41 shown in FIG. 4 asks the user whether to release chapter-on state (Ch_flag=1) through the chapter button. In this case, if the user selects YES 42, the temporary files stored when the chapter flag is set to “1” are combined. If the user selects NO 43, the temporary files are shifted to the main memory without being combined, and the power is transited off.

If the power is transited off by the user, the operation may be executed by asking the user via the display window 41 (as above). However, if the power is abnormally transited off by battery discharge or external impact, it is impossible to query the user. In such a case, if the power is transited on again or a moving picture shot mode is transited on, the display window queries the user whether to release the chapter-on state as shown in FIG. 4.

In the aforementioned exemplary embodiments, the user should maintain the chapter-on state, or release the chapter-on state by manually pressing the chapter button. In the exemplary embodiment, in addition to such a manual chaptering mode, the user may select an auto-chaptering mode in which moving-picture files stored during a unit time period are automatically combined. If the power is abnormally transited off, the auto-chaptering mode can be used in the case where the temporary moving-picture files are stored in the main memory as mentioned in the second exemplary embodiment. However, the auto-chaptering mode cannot be used in the case where the temporary moving-picture files are stored in the buffer as mentioned in the first exemplary embodiment.

FIG. 5 illustrates an example of a display window 51 for selecting a chaptering mode. The user can select either a manual chaptering list 52 or an auto-chaptering list 53 from the display window 51. Also, the user can set a unit time period for auto-chaptering through a setting list 54. The unit time period may be day, week, month, other time period, or user-defined interval.

Alternatively, if moving pictures are first produced on an arbitrary date, the display window 51 asks the user whether to chapter moving-picture files corresponding to the previous date in the unit of a day. If the user selects YES, the moving-picture files corresponding to the previous date are chaptered.

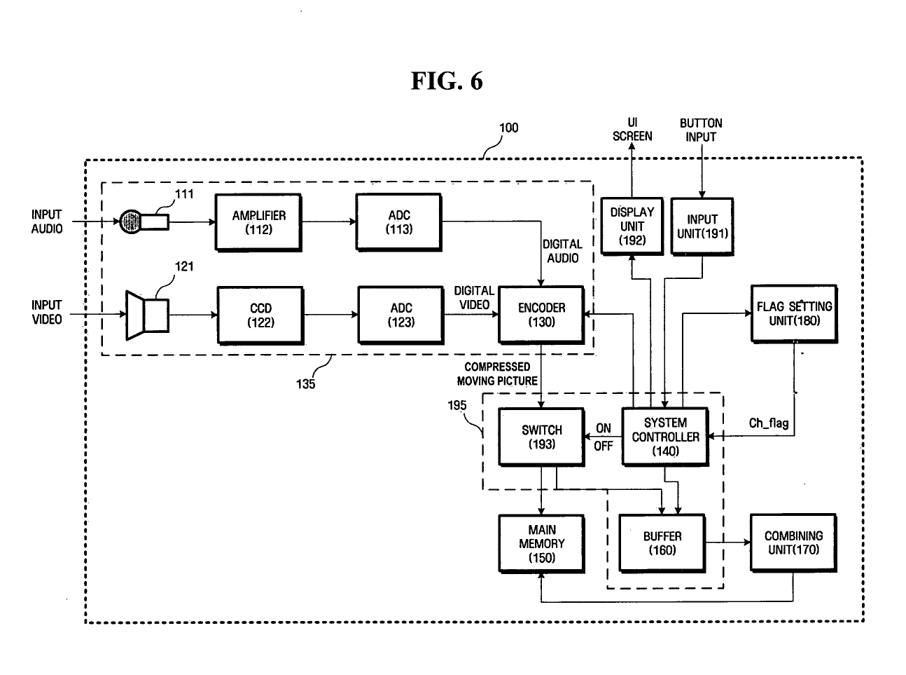

FIG. 6 is a block diagram illustrating the construction of an apparatus 100 for recording a moving picture in accordance with the first exemplary embodiment.

The apparatus 100 includes a generating means 135 that performs the function of producing moving picture files, a selecting means 195 that performs the function of selecting moving-picture files included in a interval among the generated moving-picture files, a combining unit 170 that performs the function of combining the selected moving-picture files, and a main memory 150 that performs the function of storing the combined moving-picture files. The apparatus 100 further includes a flag-setting unit 180, a display unit 192, and an input unit 191.

The generating means 135 may include a microphone or other audio input device 111, an amplifier 112, analog-to-digital converters (ADCs) 113 and 123, a camera lens or other visual input device 121, a CCD 122 (or equivalent corresponding structure as would be known by one skilled in the art), and an encoder 130. The selecting means 195 may include a system controller 140, a switch 193, and a buffer 160.

The detailed operation of the above elements will be described in the following. First, audio is input to via microphone 111 and video is input via the camera lens 121.

After the analog audio input through the microphone 111 is amplified by the amplifier 112 by a gain, the amplified audio signal is converted into a digital audio signal via the ADC 113, and is then input to the encoder 130.

Meanwhile, the CCD 122 photoelectrically converts an object picture input through the camera lens 121 and outputs a signal of a time (e.g., 1/15 second) and a size (e.g., 640×480 resolution). Noise in the signal is removed and its white balance is controlled through a pre-processing circuit (not shown). Afterwards, the camera signal is converted into digital data, i.e., a digital-video signal by the ADC 123.

The encoder 130 compresses the digital audio and the digital video using a compression method to generate compressed moving-picture files. The digital audio may be compressed in accordance with an audio compression standard such as MPEG Audio Layer-3 (MP3) or Windows Media Audio (WMA). The digital video may be compressed in accordance with a moving picture compression standard such as MPEG-1, MPEG-2, MPEG-4, H.253, or H.264. The compressed digital audio and the compressed digital video are combined to generate one compressed moving-picture file. The start and end of the moving-picture file is notified by a control signal transmitted by the system controller 150.

Meanwhile, the input unit 191 converts the user's button input into a button signal and transmits the button signal to the system controller 140. Examples of the user's button input include (but are not limited to) a power-off command, a moving-picture record command, a chapter command, and so on.

The system controller 140 may be a central processing unit (CPU), a microcomputer, or other equivalent structure. The system controller 140 receives the button signal from the input unit 191 and commands the respective elements to execute the operation corresponding to the button signal. If the button signal corresponding to the chapter button is input by the input unit 191, the system controller 140 requests the value of the chapter flag Ch_flag from the flag setting unit 180. If the button signal corresponds to the record button, the system controller 140 commands the encoder 130 to start encoding. If a record command is input again by the input unit 191, the system controller 140 commands the encoder 130 to end encoding. If the chapter flag is converted from “1” into “0”, the system controller 140 controls the buffer 160 so that the files stored in the buffer 160 can be provided to the combining unit 170.

The flag setting unit 180 stores a chapter flag, and toggles the chapter flag value if a control signal for toggling the chapter flag is input by the system controller 140. In other words, if the chapter flag is equal to “1,” the flag setting unit 180 converts the chapter flag from “1” into “0.” In contrast, if the chapter flag is equal to “0”, the flag setting unit 180 converts the chapter flag from “0” into “1.” The flag setting unit 180 provides the current chapter flag Ch_flag if the control signal requesting the chapter flag is input by the system controller 140.

If the chapter flag is equal to “1”, the system controller 140 controls the switch 193 to put the switch in an “ON” state. On the other hand, if the chapter flag is equal to “0”, the system controller 140 controls the switch 193 to put the switch in “OFF” state. Also, if the switch 193 is in the OFF state (default value), the moving-picture files transmitted from the encoder 130 to the switch 193 are stored in the main memory 150. On the other hand, if the switch 193 is in the ON state, the moving-picture files transmitted from the encoder 130 to the switch 193 are stored in the buffer 160. The files stored in the main memory 150 are the final moving-picture files that do not need to be combined, but the files stored in the buffer 160 need to be combined. Therefore, the files stored in the buffer 160 are referred to as temporary moving-picture files.

The buffer 160 temporarily stores at least one moving-picture file, i.e., a temporary moving-picture file provided by the switch 193, and provides all the temporary moving-picture files currently stored in the buffer 160 to the combining unit 170. If the temporary moving-picture files are completely provided to the combining unit 170, the buffer 160 deletes all the data stored in the buffer 160. Since the buffer 160 is a first in first out (FIFO) queue, it sequentially provides the temporary moving-picture files to the combining unit 170.

The combining unit 170 combines the temporary moving-picture files in the order that the buffer 160 provides them. The combining unit 170 combines the respective files by simply connecting the respective files with one another.

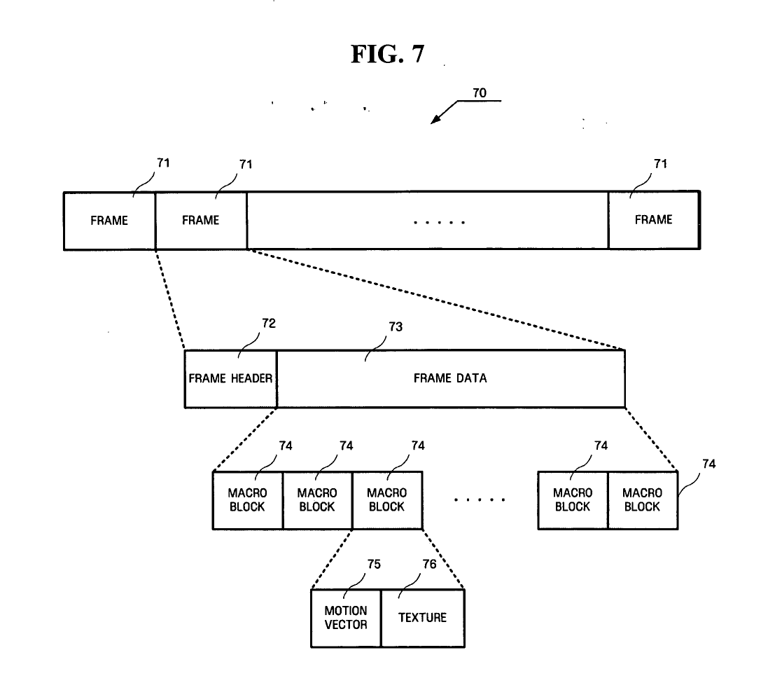

FIG. 7 illustrates an exemplary structure of the moving-picture files. One moving-picture file corresponds to one type of bit stream and includes a plurality of frames 71. One frame 71 may be divided into a frame header field 72 and a frame data field 73. Data about a specific frame is recorded in the frame header field 72, and actual data is recorded in the frame data field 73. One frame data field 73 includes a plurality of macroblocks 74. One macroblock includes a motion vector field 75 and a texture field 76. A motion vector value is recorded in the motion vector field 75 while a coded residual is recorded in the texture field 76.

Since the moving-picture files contain a plurality of frames in a successive bit stream structure, there is no problem in reproducing the moving pictures even if some of the bit stream is lost or a plurality of bit streams are combined (provided that resolution of the moving pictures and the frame rate are substantially similar).

Referring back to FIG. 6, the combining unit 170 provides the combined moving-picture files to the main memory 150.

The main memory 150 stores the moving-picture files transmitted by the encoder 130 through the switch 193, and the moving-picture files transmitted by the combining unit 170. The main memory 150 may be nonvolatile and have a considerably high capacity to store a plurality of moving pictures. Therefore, the main memory 150 may be a mass-storage, nonvolatile memory such as a flash memory or a hard disk.

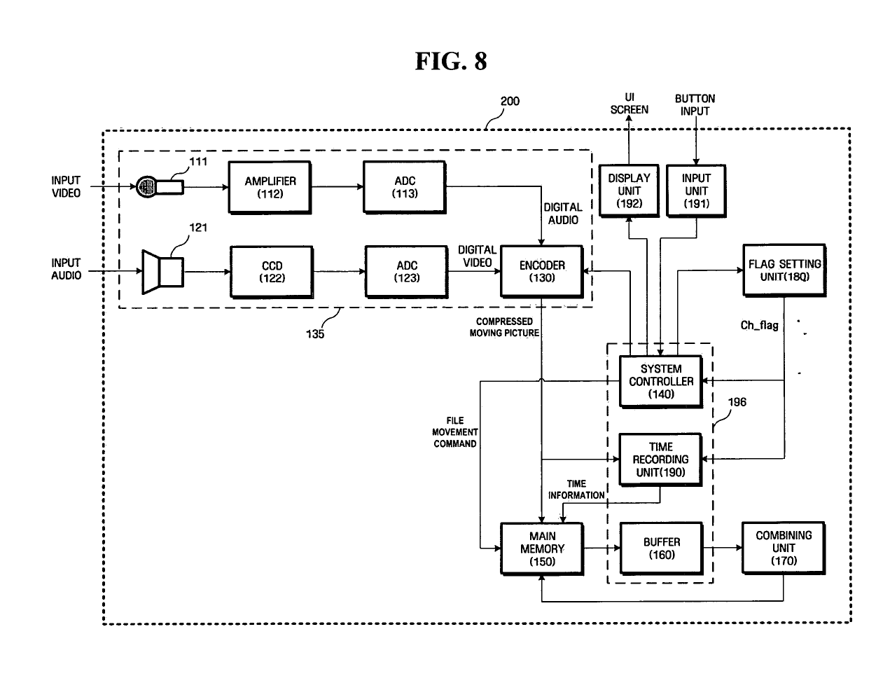

FIG. 8 is a block diagram illustrating the construction of an apparatus 200 for recording a moving picture in accordance with the second exemplary embodiment. The apparatus 200 of FIG. 8 will be described based on the elements that are different from those of the apparatus of FIG. 6 to avoid repetition of the description.

In the second exemplary embodiment, after the chapter flag is set to “1” is recorded, if the chapter flag is set to “0”, the moving-picture files stored after the recorded time are combined into one moving-picture file.

To this end, a selecting means 196 includes a system controller 140, a time recording unit 190, and a buffer 160. The system controller 140 receives a corresponding flag value Ch-flag from the flag setting unit 180 if the flag value is varied.

Meanwhile, the time recording unit 190 records a start time when the moving-picture files are input from the encoder 130, and an end time when the input of the moving-picture files to the main memory is completed. If the start time and the end time are recorded, the recording time of all the frames constituting the moving-picture files can be calculated by frame rate of the moving-picture files. Also, the time recording unit 190 records the time (flag-on time) when the main memory 150 receives the flag having a value of “1” from the flag setting unit 180.

Afterwards, the system controller 140 shifts the moving-picture files stored after the flag-on time among the moving-picture files stored in the main memory 150 to the buffer 160 if the flag having a value of “0” is received from the flag-setting unit 180.

Then, the combining unit 170 combines the temporary moving-picture files provided by the buffer 160 into one moving-picture file, and provides the combined moving-picture file to the main memory 150.

The description of the apparatuses shown in FIG. 6 and FIG. 8 has been based on the manual chaptering mode that allows the user to press the chapter button. If the user interface screen shown in FIG. 5 is provided to the user through the display unit 192, and the auto-chaptering mode is selected by the user, the auto-chaptering mode is executed. The display unit 192 may be a liquid crystal display (LCD), a plasma display panel (PDP), or an organic light emitting diode (OLED), or equivalent structure thereto as would be envisioned by one skilled in the art.

In the auto-chaptering mode, the chapter button input from by user is discarded, and the flag setting unit 180 sets the chapter flag to “1” when a specific unit period starts and sets the chapter flag to “0” when the specific unit period ends. For example but not by way of limitation, if the specific unit period is designated as a “day,” the flag setting unit 180 sets the chapter flag to “1” at the beginning of every day. Afterwards, the flag setting unit 180 sets the chapter flag to “0” directly before the unit period ends (to obtain the combining time). In this case, the temporary moving-picture files stored in the buffer 160 are combined by the system controller 140 and the combining unit 170. When the next day begins, the flag setting unit 180 sets the chapter flag to “0”.

However, the apparatus 100 is rarely transited on at the beginning of the day. Therefore, in this case, the flag setting unit 180 may set the chapter flag to “0” when the power is transited on so that the moving-picture files can be combined as above. After the moving-picture files are completely combined, the flag setting unit 180 converts the chapter flag into “1” again.

In the aforementioned exemplary embodiment, the processing operation performed when the chapter button is pressed while the moving picture is being recorded has not been described. No operation occurs even if the chapter button is pressed while the moving picture is being recorded.

On the other hand, in another exemplary embodiment, there may be provided a case where the function of the chapter button is automatically performed. In such an exemplary embodiment, a corresponding function is performed regardless of whether the chapter button is pressed while the moving picture is being recorded.

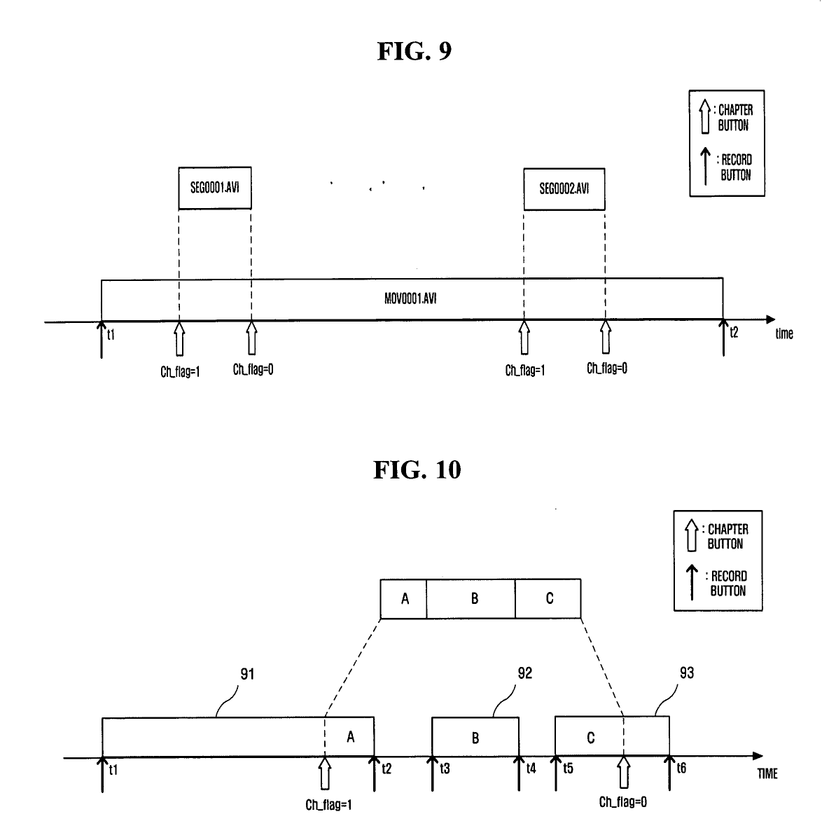

If the chapter button is pressed while a moving picture is being recorded, and the chapter flag of “1” (chapter-on state) is set as shown in FIG. 9, the moving-picture files SEG0001.AVI and SEG002.AVI are stored separately from the whole moving-picture file MOV0001.AVI. This is because that the user may desire to separately store a specific moving picture even in the case where the moving picture is being recorded. If the specific moving-picture file is not divided from the whole moving-picture file, an editing operation for cutting some of the moving-picture file MOV0001.AVI is separately required, and this may not be easy for a general user.

FIG. 10 illustrates a general example where the chapter button is pressed. When the user presses the recording button six times to generate three moving-picture files 91, 92 and 93, it is considered that the chapter-on period has been set by the chapter button. If the moving-picture files 91, 92 and 93 have been generated, the moving-picture files A, B and C corresponding to the chapter-on period are combined. The combined files may be the entire moving-picture files 91, 92 and 93, or some segment of the moving-picture files 91, 92 and 93.

As described above, all the moving-picture files (regardless of part of the moving-picture files, or the whole moving-picture files) within the chapter-on period can be combined.

Many exemplary logic blocks, modules, and circuits, which have been explained in relation to exemplary embodiments \, may be implemented or performed by a general processor, a digital signal processor (DSP), an application specific integrated circuit (ASIC), a field programmable gate array (FPGA) or another programmable logic device, a discrete gate or transistor logic device, discrete hardware components, or a combination thereof. The general processor may be a microprocessor, or optionally may be a specific related art processor, a controller, a microcontroller, or a state machine. Also, the processor may be implemented by a combination of computing devices, for example but not by way of limitation, a combination of a DSP and a microprocessor, a plurality of microprocessors, one or more microprocessors related to a DSP core, or certain other constructions thereof.

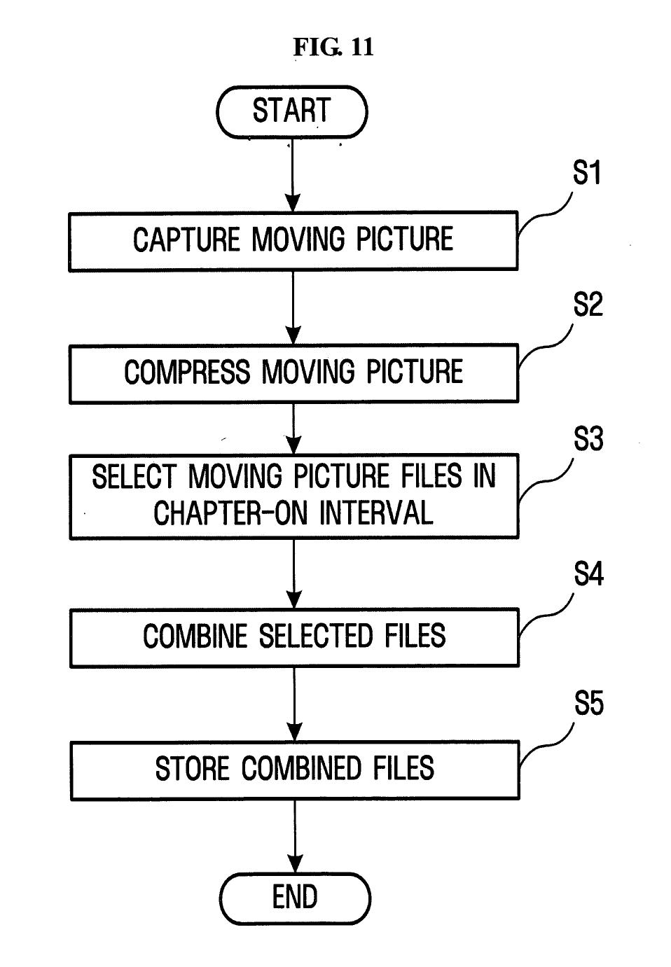

FIG. 11 is a flowchart illustrating a method for recording a moving picture in accordance with the exemplary embodiment. The method for recording a moving picture includes an operation S1 of capturing moving pictures, an operation S2 of compressing the moving pictures, an operation S3 of selecting moving-picture files in the chapter-on period, an operation S4 of combining the selected moving-picture files, and an operation S5 of storing the combined file. The operation S1 is performed until the user presses the record button (or stop button) a second time.

In the operation S1, input video is converted into a digital video signal through the camera lens 121, the CCD 122, and the ADC 123. The camera lens 121 receives the video, and the CCD 122 photoelectrically converts a picture received via the camera lens, and outputs a camera signal of a size and time. The pre-processing circuit (not shown) removes noise and controls the white balance of the camera signal. This operation may be omitted. The ADC 123 converts the resultant signal into a digital video signal.

Then, in the operation S2, the decoder 130 compresses the converted digital video signal using a compression method. The compression method may be one of MPEG-1, MPEG-2, MPEG-4, H.263, and H.264.

The apparatus for recording a moving picture is generally provided with a microphone 111 for inputting audio. The audio input to the microphone 111 is amplified by the amplifier 112, and then converted into the digital audio signal through the ADC 113. The encoder 130 compresses the converted audio signal using an audio compression method such as MP3, WMA, and so on. The audio encoder and the video encoder may be separate.

In the operation S3, the selecting means 195 selects the moving-picture files corresponding to the chapter-on period among the compressed moving-picture files. Various elements may be used as the selecting means 195. In FIG. 6, the switch 193, the system controller 140, and the buffer 160 may function as the selecting means. In other words, the switch 193 is controlled by the system controller 140 via the chapter-on period. If the switch 193 is transited on, the moving-picture files compressed by the encoder 130 are all stored in the buffer 160. During the chapter-on state the moving-picture files can be separately collected and selected. In FIG. 8, a start time when storage of the moving-picture files began, an end time when storage of the moving-picture files ended, and a flag-on time (the time when the flag was converted to “1”) are recorded. Afterwards, if the flag is converted to “0”, moving-picture files are selected after the flag-on time. In addition, the moving-picture files may be selected in various manners.

Next, in the operation S4, the combining unit 170 combines the selected moving-picture files. The combining operation may be performed by simple combination of bit streams for the selected moving-picture files.

Finally, in the operation S5, the main memory 150 stores the moving-picture files provided by the combining unit 170.

The chapter-on period can be set to “1” (on state) or “0” (off state). However, the condition that the flag value is converted from “1” into “0”, and vice versa may be varied depending on the manual chaptering mode or the auto-chaptering mode.

In the manual chaptering mode, the condition means that the chapter button has been pressed by the user. However, in the auto-chaptering mode, the condition means that the set unit time period (day, week, month, and so on) has started or ended.

The method for recording a moving picture according to the exemplary embodiment considers that the power is transited off in the chapter-on state. In the apparatus 100 for recording a moving picture, if the power-off button is pressed in the flag-on state, the display window shown in FIG. 4 is displayed via the display unit 192 to allow the user to decide whether to combine the moving-picture files. The combining operation is performed only if YES 42 is selected.

Meanwhile, if the power is abnormally transited off in the flag-on state, the display window shown in FIG. 4 is displayed to allow the user's selection when the power is transited on again or the moving-picture shot mode is in the on state.

As described above, in the method and apparatus for recording a moving picture according to the exemplary embodiments, since the user can record one moving-picture file per desired unit (e.g., event), no additional moving-picture editing operation is required.

Additionally, the foregoing exemplary embodiments may be implemented in a computer-readable medium stored in, for example by not by way of limitation, a processor. The computer-readable medium may include instructions to perform the operations disclosed above with respect to the exemplary embodiments.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for recording a moving picture in accordance with a record command, the method comprising:
capturing moving pictures to generate moving-picture files;
selecting at least two of the moving-picture files included in a interval among the generated moving-picture files;
combining the selected moving-picture files; and
storing the combined moving-picture files.

2. The method of claim 1, wherein the interval is from when a predetermined flag is in an ON state to when the flag is in an OFF state.

3. The method of claim 2, wherein the flag in the ON or OFF state is toggled therebetween by a predetermined button pressed by a user.

4. The method of claim 1, wherein the interval is a period from start time to end time set by the user.

5. The method of claim 4, wherein the period is determined as a unit time period by the user.

6. The method as claimed in claim 1, further comprising:
recording a flag in an ON or OFF state in accordance with a condition; and
reading the recorded flag.

7. The method as claimed in claim 6, wherein the condition is operating a button.

8. The method as claimed in claim 6, wherein the condition is starting or ending a unit time period.

9. The method as claimed in claim 1, wherein the capturing the moving pictures to generate the moving-picture files comprises:
generating a digital video signal from an input video; and
compressing the digital video signal using a video compression method.

10. The method as claimed in claim 9, wherein the capturing the moving pictures to generate the moving-picture files further comprises:
generating a digital audio signal from an input audio; and
compressing the digital audio signal in an audio compression method.

11. The method as claimed in claim 9, wherein the generating the digital video signal from the input video comprises:
photoelectrically converting an object picture input through a camera lens, and outputting a camera signal having a size and a time;
removing noise and controlling a white balance of the output camera signal; and
converting a final signal resulting from the controlled camera signal into a digital video signal.

12. The method as claimed in claim 9, wherein the video compression method is one of MPEG-1, MPEG-2, MPEG-4, H.263, and H.264.

13. The method as claimed in claim 1, wherein the moving-picture files are generated from scenes captured by the camera lens during a time period from when a record button is operated a first time to when the record button is operated a second time.

14. The method as claimed in claim 1, wherein selecting at least two of the moving-picture files comprises storing the generated moving-picture files in a buffer by controlling an operation of a switch.

15. The method as claimed in claim 14, wherein the combined moving pictures are stored in a memory separate from the buffer.

16. The method as claimed in claim 6, wherein the selecting at least two of the moving-picture files comprises recording an ON time of the flag, and selecting the moving-picture files generated after the flag-on time among the generated moving-picture files when the flag is in the OFF state.

17. The method as claimed in claim 1, wherein the combining the selected moving-picture files comprises combining bit streams for the selected moving-picture files.

18. The method as claimed in claim 6, wherein if a power-off button is operated when the flag in the ON state, a display window is displayed to the user to allow the user to decide whether to combine the moving-picture files.

19. The method as claimed in claim 6, wherein if the power is abnormally transited off when the flag is in the ON state, a display window is displayed to allow a user to decide whether to combine the moving-picture files when the power is transited on.

20. The method as claimed in claim 6, wherein if the power is abnormally transited off when the flag is in the ON state, a display window is displayed to allow a user to decide whether to combine the moving-picture files when the power is transited on again and a moving-picture shot mode is executing.

21. An apparatus for recording a moving picture in accordance with a record command, the apparatus comprising:
means for taking moving pictures to generate moving-picture files;
means for selecting at least two moving-picture files included in a interval among the generated moving-picture files;
means for combining the selected moving-picture files; and
main memory that stores the combined moving-picture files.

22. The apparatus as claimed in claim 21, further comprising a flag setting unit that records a flag in an ON or OFF state in accordance with a condition, and reads the recorded flag.

23. The apparatus as claimed in claim 22, wherein the condition is operating a button.

24. The apparatus as claimed in claim 22, wherein the condition is starting or ending a unit time period.

25. The apparatus as claimed in claim 22, wherein the means for taking moving pictures to generate the moving-picture files comprises:
means for generating a digital audio signal from input audio; and
an encoder that compresses the digital audio signal.

26. The apparatus as claimed in claim 22, wherein the means for taking moving pictures to generate the moving-picture files comprises:
a means for generating a digital video signal from an input video; and
an encoder that compresses the digital video signal.

27. The apparatus as claimed in claim 26, wherein the means for taking moving pictures to generate the moving-picture files comprises:
a charge coupled device that photoelectrically converts a picture received by a camera lens, and outputs a camera signal having a size and a time; and
an analog to digital converter that converts the camera signal into a digital video signal.

28. The apparatus as claimed in claim 26, wherein the encoder compresses based on one of MPEG-1, MPEG-2, MPEG-4, H.263, and H.264.

29. The apparatus as claimed in claim 21, wherein the moving-picture files are generated from scenes received by the camera lens during a time period from when a button is operated a first time to when the button is operated a second time.

30. The apparatus as claimed in claim 22, wherein the means for selecting at least two moving-picture files stores the generated moving-picture files in a buffer based on control of an operation of a switch.

31. The apparatus as claimed in claim 22, wherein the means for selecting at least two moving-picture files records the ON time of the flag, and selects the moving-picture files generated after the flag-ON time among the generated moving-picture files when the flag is in the OFF state.

32. The apparatus as claimed in claim 30, wherein the combined moving pictures are stored in the main memory and separate from the buffer.

33. The apparatus as claimed in claim 21, wherein the means for combining the selected moving-picture files combines bit streams for the selected moving-picture files.

34. The apparatus as claimed in claim 22, wherein if a power-off button is operated in the ON state of the flag, a user is prompted to identify whether to combine the moving-picture files.

35. The apparatus as claimed in claim 22, wherein if the power is abnormally transited off when the flag is in the ON state, a user is prompted to decide whether to combine the moving-picture files when the power is transited on.

36. The apparatus as claimed in claim 22, wherein if the power is abnormally transited off when the flag is in the ON state, a user is prompted to decide whether to combine the moving-picture files when the power is transited on and a moving-picture shot mode is executing.

37. A computer-readable medium comprising a set of instructions for recording a moving picture in accordance with a record command, the method comprising:
capturing moving pictures to generate moving-picture files;
selecting at least two moving-picture files included in a interval among the generated moving-picture files;
combining the selected moving-picture files; and
storing the combined moving-picture files.
